(19) United States
(12) Patent Application Publication
(10) Pub. No.: US 2008/0135592 A1
(43) Pub. Date: Jun. 12, 2008

(54) Removable Cargo Rack for the Side of a Car

(76) Inventor: Vincent Paul Corso, San Francisco, CA (US)

Correspondence Address: CAHN & SAMUELS LLP, 1100 17th STREET NW, SUITE 401, WASHINGTON, DC, 20036, US

(21) Appl. No.: 11/608,597

(22) Filed: Dec. 8, 2006

(51) Int. Cl. B60R 9/00

(52) U.S. Cl. 224/555

(57) ABSTRACT

A removable cargo rack for carrying elongated and oversized materials alongside a car comprising an anchor end adapted to removably engage the open window of the car door, a cargo end adapted to retain and support the cargo, and a downwardly extending arm between the anchor end and the cargo end. Also disclosed is an assembly with a connection member connecting a plurality of removable cargo racks, wherein the connection member can be adapted to retain and support the cargo.

### I. FIELD OF THE INVENTION

The present invention related to devices for carrying cargo. More particularly, the present invention relates to a removable cargo rack mountable on the opened window of a car door for carrying elongate and oversized items alongside the car.

### II. BACKGROUND OF THE INVENTION

While SUV's and pick-up trucks are capable of hauling large cargo, today's compact, mid-size and full-size cars are too small to carry large items such as lumber, carpet, and drywall. When such items are transported in a car, they must be placed diagonally across the car's seats, typically with parts of the item sticking through an open window. This configuration is hazardous, awkward and can cause damage to the inside of the car.

Alternatively, large items might be stowed in the car's trunk, typically resulting in the trunk being left open and the object partially sticking out. In this configuration, the cargo is subject to falling if not properly secured, and the cargo or the open trunk can block the driver's rear vision. The trunk also does not allow a car owner to transport long items.

There are few options for transporting large items on the exterior of a car. Objects might be mounted on the car's roof. However, in this configuration, items are prone to fall if not carefully secured. Also, there is no way to support long items extending past the edge of the car roof. Thus, the ends of carpet, wood strips or other long items can bend down, blocking the driver's vision and possibly causing damage to the car's hood. The absence of support might also cause bending or breaking of the items themselves. Transporting objects on the top of the car can also scratch the car roof, particularly if there is no luggage rack. Loading and unloading sometimes heavy or bulky cargo on a car roof is also difficult for shorter individuals.

While racks might be available for some cars roofs (for example, luggage racks) and the backs of some cars (such as a bike rack or a rack for a spare tire), these racks are typically permanent and expensive, and they take away from the car's appearance. Even racks that are made to be removable still suffer from many drawbacks in that such racks require significant time and effort to attach to the car and, once attached, are not easily removed.

The foregoing underscores some of the problems associated with conventional means for carrying oversized items in today's automobiles. Furthermore, the foregoing highlights the long-felt, yet unresolved need for an inexpensive, easily removable and/or disposable rack for carrying elongated and oversized cargo via automobile. The foregoing also highlights the long-felt, yet unresolved need for a removable cargo rack mountable on the side of an automobile for carrying elongate and oversized materials alongside the vehicle.

### III. SUMMARY OF THE INVENTION

It is an object of at least one embodiment of the invention to overcome the foregoing exemplary shortcomings and problems.

It is another object of at least one embodiment of the invention to provide a safe and convenient rack for carrying oversized objects on the side of a car.

It is yet another object of at least one embodiment of the invention to provide a side car rack that is inexpensive and easily removed.

In one embodiment of the invention a removable cargo rack includes an anchoring end adapted to removably engage the open window of the car door, a cargo end adapted to retain and support the cargo, and a downwardly extending arm disposed between the anchor end and the cargo end. In another embodiment, a cargo rack assembly including, for example, two removable cargo racks and a connection member that attaches to the cargo ends of the racks and retains and supports the cargo.

In the following enabling description, reference is made to the accompanying drawings which are shown by way of illustration of the specific embodiments in which the invention may be practiced. In the following embodiments the apparatus and methods should become evident to a person of ordinary skill in the art and in sufficient detail to enable those skilled in the art to practice the invention. It is to be understood that other embodiments may be used and that structural changes based on presently known structural and/or functional equivalents may be made without departing from the scope of the invention.

### IV. BRIEF DESCRIPTION OF THE DRAWINGS

The following enabling description is provided with reference to the accompanying figures wherein:

FIG. 1 is a cross-sectional view of an embodiment of a rack member according to the invention.

FIG. 2 is a perspective view of an embodiment of a cargo rack assembly including two removable cargo racks.

FIG. 3 depicts a rear view of the embodiment of FIG. 2.

FIG. 4 is an assembly view of an alternative embodiment of a cargo rack including two removable rack members and a cargo basket according to the invention.

FIG. 5 is an assembly view of an embodiment of a cargo basket with an adjustable joint according to the invention.

FIG. 6 is a perspective view of the assembled embodiment of FIG. 4.

FIG. 7 is a rear view of the assembled embodiment of FIG. 4.

FIG. 8 is a perspective view of an embodiment of a cargo rack assembly including two removable cargo rack members and a connection member according to the invention.

FIG. 9 depicts a rear view of the embodiment of FIG. 8.

FIG. 10. is an embodiment of the removable cargo rack having adjustable joints according to the invention.

FIG. 11. is an embodiment of the anchor end of FIG. 10.

FIG. 12. is another embodiment of an anchor end according to the invention.

FIG. 13. is a further embodiment of an anchor end according to the invention.

FIG. 14. is a perspective view of an embodiment of a custom cargo rack for carrying skis according to the invention.

FIG. 15. is a perspective view of another embodiment of a custom cargo rack assembly for carrying a surfboard according to the invention.

While the present invention will be described and disclosed in connection with certain preferred embodiments and uses, it is not intended to limit the invention to those specific embodiments and uses. Rather it is intended to cover all such alternative embodiments and modifications as fall within the scope and spirit of the invention.

### V. DETAILED DESCRIPTION OF THE INVENTION

Generally, the present invention relates to devices for carrying cargo alongside a vehicle, and in particular, removable cargo racks for carrying elongated or oversized cargo. While the present invention is described in connection with removable cargo racks for use by mounting within the opened window of two or four door cars, it will be readily appreciated by one of ordinary skill in the art that the teachings of the present invention can be applied to a variety of rack configurations for transporting a variety of cargo for any desired vehicle.

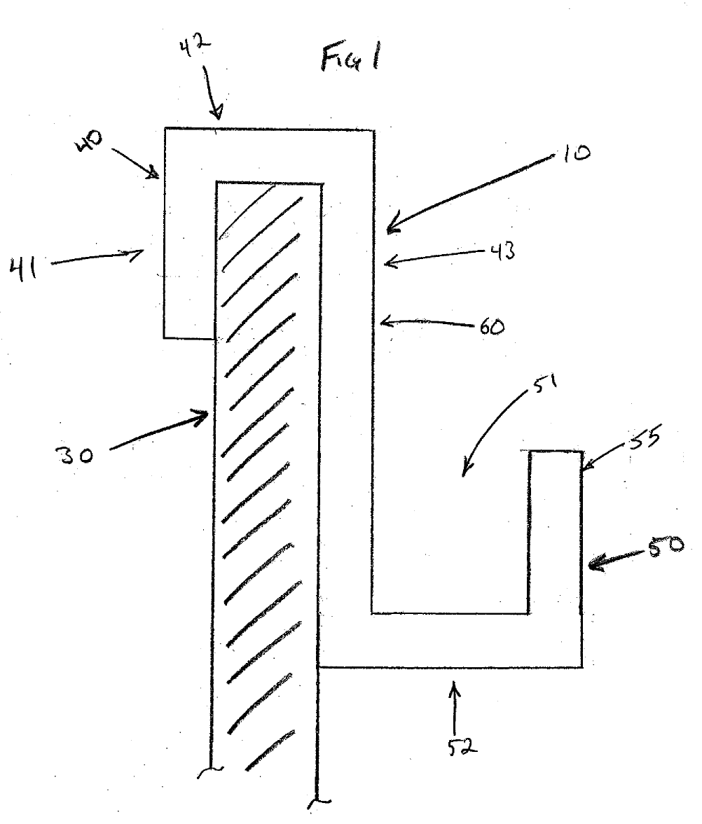

A presently preferred embodiment of a removable cargo rack 1 incorporating various advantages features of the invention is depicted in FIG. 1. As shown, the cargo rack may comprise a removable cargo rack member 10 configured for operative deployment in the open window 20 of a car door 30. While the exact configuration of the rack member 10 is not critical to the invention, in the depicted embodiment of FIG. 1 the cargo rack member 10 is shaped as a unitary member having a serpentine cross-section and comprising an anchor end 40 adapted to removably engage the open window 20 of the car door 30, a cargo end 50 adapted to retain and support the cargo 70, and a downwardly extending arm 60 disposed between the anchor end 40 and the cargo end 50.

In the embodiment illustrated in FIG. 1, the anchor end 40, the cargo end 50, and the downwardly extending arm 60 are integrally formed as a single piece. As will be appreciated, unitary construction of the cargo rack member 10, from metal or plastic for example, may be preferred due to the ease of mass production, low cost of construction, and strength advantages resulting from the absence of welds or joints, as well as other known benefits. Alternatively, as will be discussed in connection with other embodiments herein, one or more of the component parts of the cargo rack member 10 might be constructed separately (with telescoping joints 110, for example) to adapt the rack member 10 to different shapes, sizes and types of cargo 70 to be carried on cars and car doors 30 of different shapes and sizes.

According to one advantageous feature of the invention, a single piece construction might provide cost savings on a scale allowing the rack 1 to be considered disposable. For example, an inexpensive disposable invention would allow individuals who purchase oversized cargo at hardware stores such that operated by Homer TLC, Inc. under the tradename Home Depot® to also purchase a cargo rack 1 for transporting the cargo 70. Once the cargo 70 is transported to its final destination and unloaded, the rack 1 may simply be thrown away after serving its limited purpose.

Returning to the embodiment of FIG. 1, the anchor end 40 of the cargo rack member 10 has an inverted “U” or similar shape that has an inside gripping portion 41 for engaging the interior side of the door 30, a spanning portion 42 sized to span the width of the door 30, and an outside portion 43 extending down the exterior side of the car door 30. This configuration allows for gravitational anchoring of the rack member 10 with the door 30 of the vehicle.

The spanning portion 42 of the anchor end 40 is preferably sized to traverse at least the standard width of car doors 30, and preferably the widest width of doors 30 on vehicles in the market. To achieve suitable gravitational anchoring with the door, the inside gripping portion 41 descends partway down the inside of the car door 30 and is of a size and length to ensure that a predetermined weight will hold the rack member 10 in place in the vertical direction. The inside gripping portion 41 is also preferably sized to hinder dislodging of the rack member 10 in the lateral direction when subjected to the forces of inertia during turns of the vehicle.

In this embodiment, the outside portion 43 of the anchor end 40 is essentially the top of the downwardly extending arm 60 of the rack member 10. Depending on the desired properties of the anchor end 40, the outside portion 43 may or may not be separate from the arm 60. According to an aspect of the invention, the outside portion 43 of the anchor end 40 is preferably configured to cooperate with the inside gripping portion 41 in a manner to ensure gravitational locking and otherwise to hold or limit movement of the rack member 10 and/or its cargo 70.

According to one feature of the invention, the anchor end 40 may also be configured with, for example, either inwardly biased or rigid sided inside gripping portions 41 or outside portions 43 that allow the anchor end 40 to frictionally squeeze as well as gravitationally lock onto the door 30. This not only allows use of the same size anchor 40 for varying door widths, but also hinders potential lateral movement of the rack member 10 along the door 30. This configuration holds the cargo rack member 10 onto the car door 30 not only by the weight of the cargo 70 but also by squeezing pressure on the car door between the inside gripping portion 41 and the downwardly extending arm 60.

The downwardly projecting arm 60 of the rack member 10 is preferably sized to ensure that the cargo area 51 of the cargo end 50 is above the ground yet low enough to hold typical loads of cargo 70 below the window level of the vehicle. As will be appreciated, an aspect of this embodiment of the invention is to allow transportation of cargo 70 in a manner that will not block the field of vision of the driver. According to this aspect, the arms 60 on various racks 10 might be of different lengths, such that the length of a particular rack member 10 and arm 60 are selected for the particular cargo 70 being transported. For example, transporting a piece of pipe might be accomplished using a rack member 10 having a 6-inch arm 60, whereas transporting a load of lumber or a 10-foot ladder might be carried out using a rack 10 with a two-foot arm 60. One of ordinary skill in the art armed with the present specification will readily appreciated that any combination of rack features, such as arm 60 length, might be configured depending on the cargo 70 to be carried.

The cargo end 50 of the rack 10 is preferably configured to provide an area 51 for cargo 70 to be placed and held for transport. Preferably, the cargo end 50 is configured to hold and support the cargo 70 off the ground and snuggly alongside the car. The rack 10 may have a cargo end 50 of any suitable width. For example, a three-foot long base 52 of the cargo end 50 might be provided to hold and support cargo 70 alongside the car. However, in a presently preferred embodiment, weight and mobility considerations dictate use of a relatively narrow base 52 and further contemplate a connection member 170, for example a cargo basket 53, or even the use of multiple rack members 10 to support and retain cargo 70 in a manner that spans the length of the car, as described below in connection with other Figures. In any event, the provision of an area 51 for supporting cargo 70 alongside the car during transportation is achieved by the provision of a suitable cargo end 50.

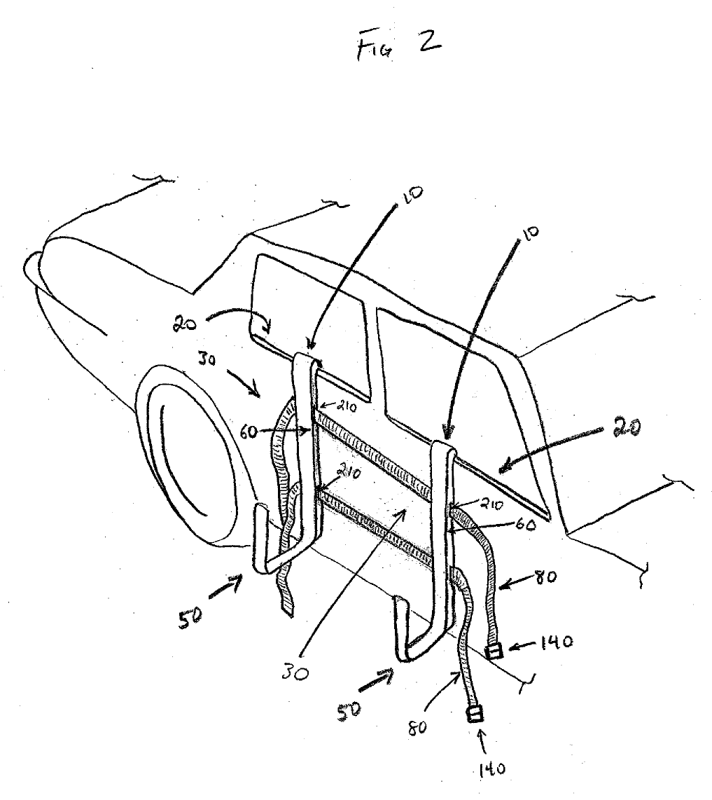

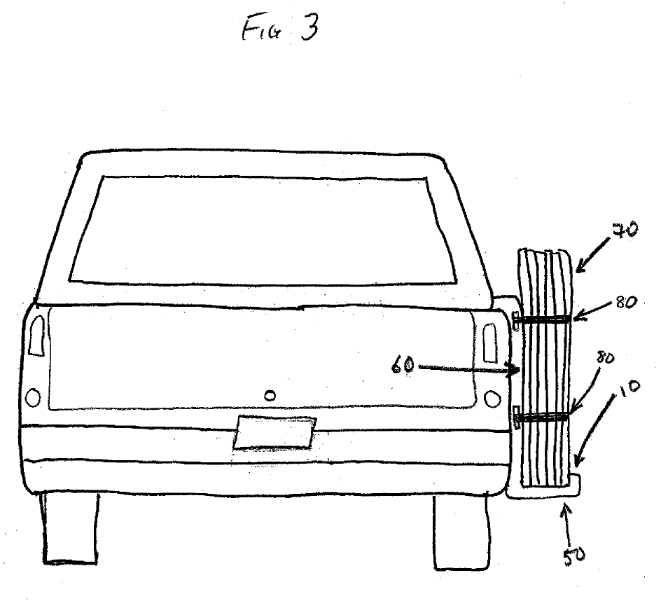

FIGS. 2 and 3 illustrate an embodiment of the invention wherein two cargo rack members 10 are cooperatively positioned to carry oversized cargo. As shown, the rack 1 utilizes a pair of slim cargo rack members 10 that are mounted into a respective front passenger and rear passenger side window opening. In this embodiment, the cargo rack members 10 include long arms 60 particularly suited for carrying a load of dry wall 70. As previously mentioned, one feature of the invention is to size the arms 60 of the rack members 10 of a length to allow the cargo to be carried at a level alongside the car that minimizes the obstruction of the driver's field of vision.

When more than a single rack member is employed, the rack members 10 are preferably spaced a predetermined distance apart to insure the cargo to be transported will be held as a balanced load. In this regard, it is also preferable that the cargo end 50 of the rack members 10 be sized to hold the intended cargo in a manner to minimize movement of the cargo during transport. In accordance with this aspect of the invention, as discussed in connection with other embodiments, the cargo end 50 may be made adjustable to accommodate load of varying widths. Alternatively, with the fixed width cargo ends 50 such as that depicted in FIGS. 2 and 3, packing members (not shown) may be inserted between the load and the lip of the cargo end 50 to press the cargo load into a friction fit arrangement with the arms 60.

To secure the cargo 70, the arms 60 of the rack members 10 in this embodiment also include a pair of slits 210 for receiving belts, straps, rope 80 or the like. Thus, once the cargo is loaded onto the cargo ends 50 of the rack members 10 (preferably in a friction fit arrangement with the arms 60) the cargo may be secured from movement via straps 80. Straps 80 include adjustable buckles 140 that allow the straps to be pulled and secured as tightly as practicable. As will be appreciated, the cargo must be secured tightly enough to protect from spillage due to the forces of inertia typically encountered with motor vehicle travel. Straps which encircle the cargo in at least the latitudinal direction secured to the vehicle via the anchoring power of the rack members should suffice to prevent the movement of the cargo during the acceleration, turning and stopping of the vehicle.

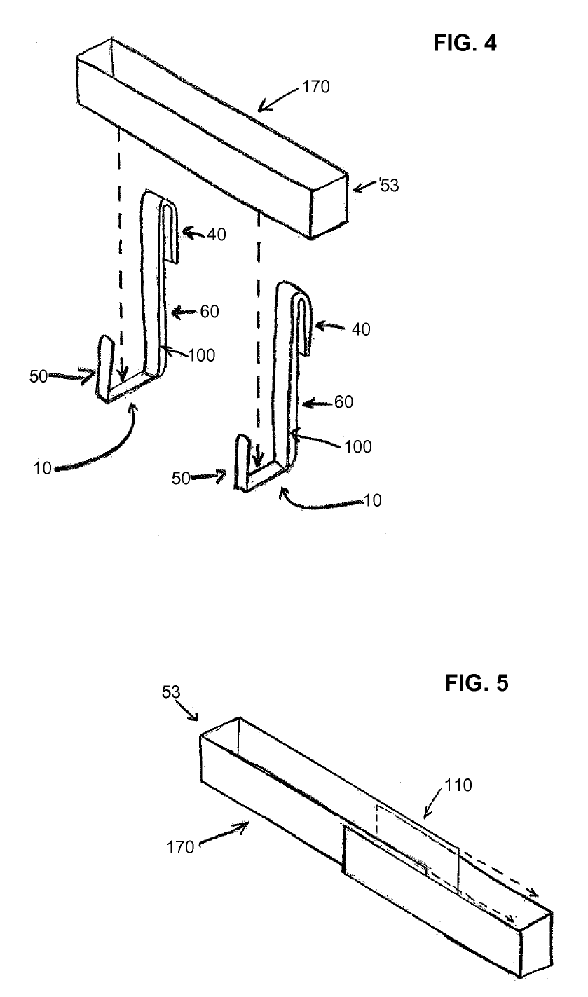

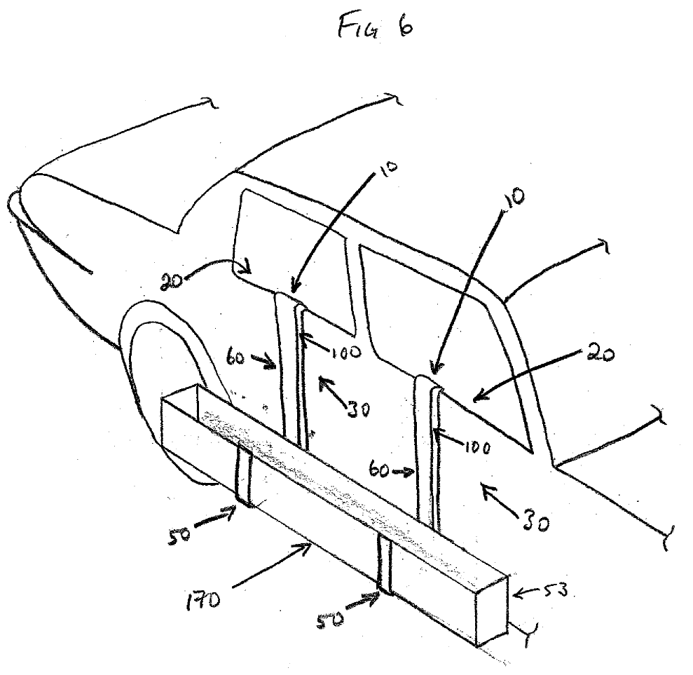

FIGS. 4-7 depict another embodiment of a cargo rack 1 using multiple rack members 10. The rack 1 of FIGS. 4-7 is particularly suited for transporting loose cargo or cargo lacking the height profile to be securable using the racks with straps configuration of FIGS. 2 and 3. As shown in FIG. 4, this cargo rack 1 also contemplates use of a pair of slim rack members 10 having a serpentine configuration, wherein the rack member 10 includes an anchoring portion 40 for securing the rack member 10 to the vehicle, a downwardly extending arm 60 for displacing a load out of the field of vision, and a cargo end 50 for receiving cargo.

According to this embodiment, the cargo end 50 of each rack member 10 is preferably configured to receive and hold a removable cargo basket 53. The cargo basket 53 can be of any suitable size for its intended purpose. In an alternate embodiment, a single rack member 10 is used, such as for use with a two door car, and the cargo basket 53 is made integral with the cargo area 50 of the rack member 10 to prevent tipping of the basket 53 and rack during transport.

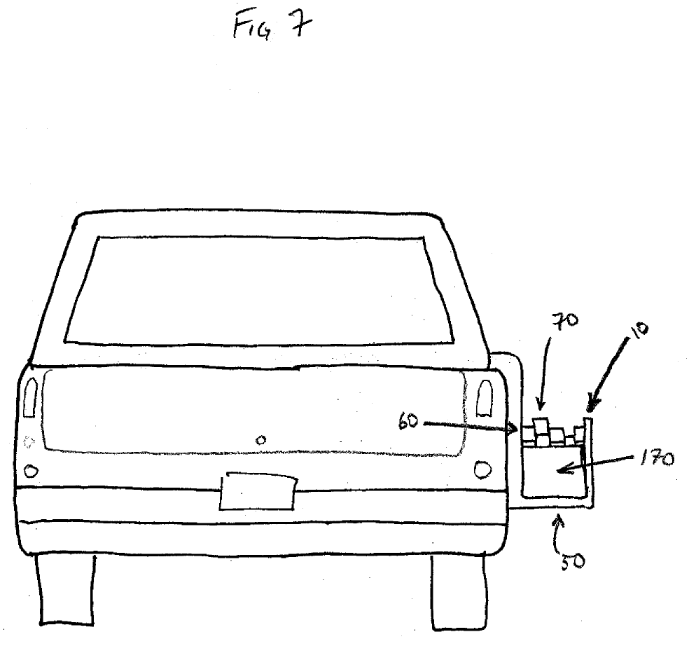

According to another aspect of the invention, cooperating cargo ends 50 and baskets 53 can be manufactured for carrying specific lengths and widths of cargo. Likewise, the basket 53 can be of a height that provides for transport of cargo loads of desired sizes. For example, as depicted in FIG. 7, a cargo basket 53 may be particularly useful when transporting lumber, PVC tubing, or similar loose and elongate materials 70. However, the invention should not be deemed limited to any specific size, shape, configuration or cargo potential for the disclosed basket 53. The basket 53 may also be provided with a cover, top, tarp, or other device for securing the loose cargo 70 from exiting the basket during transport.

As shown in FIG. 5, the cargo basket 53 may also be configured to be adjustable. While it is well within the ability of one of ordinary skill in the art to construct an adjustable basket using known techniques, a presently preferred technique provides use of a telescoping joint 110. The provision of a telescoping joint 110 not only allows the basket 53 to be expanded to any desired length and locked into place, but also allows the basket to be collapsed into itself to reduce its length to a manageable size for ease of storage. As will be appreciated, like the embodiment depicted in FIGS. 2 and 3, the embodiment of FIGS. 4-7 uses separate rack members. The use of separate rack members and a removable, collapsible basket provide for the ease of bundling the cargo rack assembly 1 into a size suitable for storage in the trunk of a car. Thus, in addition to contemplating disposable racks, the present invention contemplates racks having constituent parts that may be removed and bundled into a space saving kit for storage.

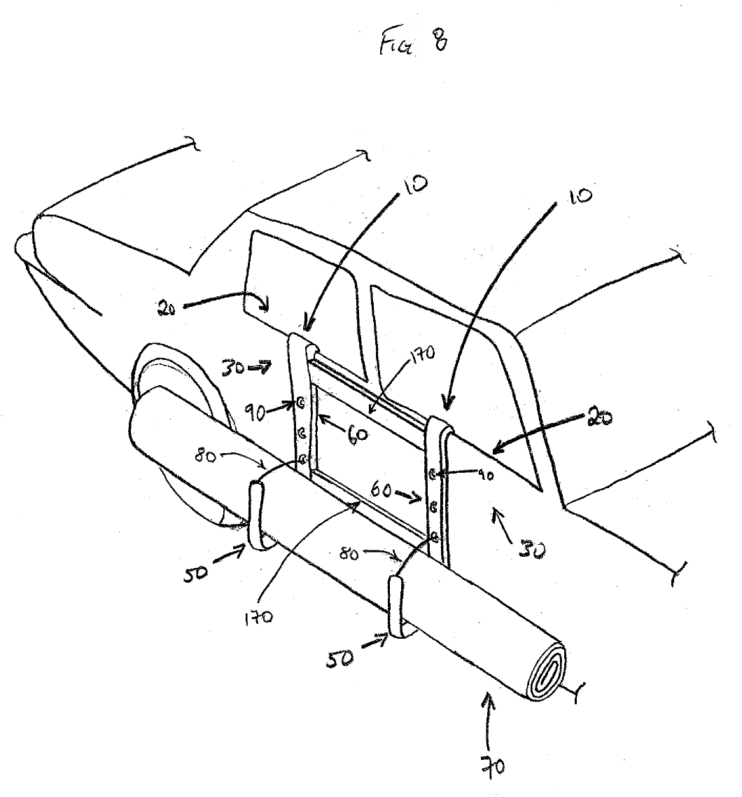

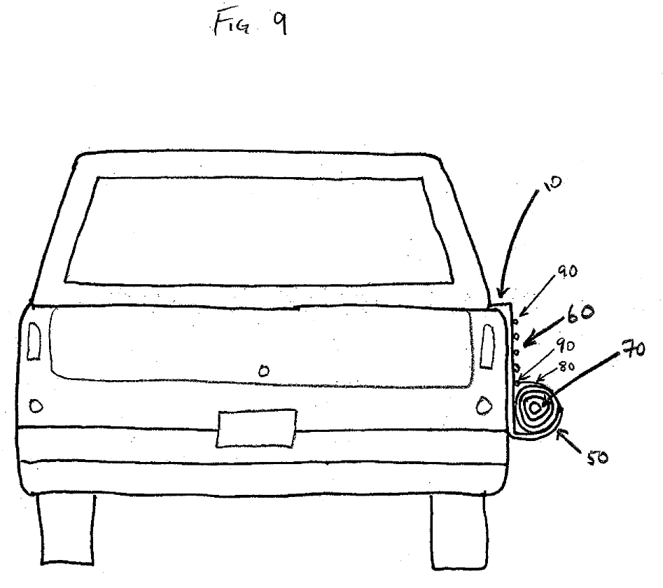

FIGS. 8 and 9 depict an embodiment of the invention that may also lend itself to disassembly for storage. The embodiment of FIGS. 8 and 9 contemplate a more rigid arrangement between the cooperating rack members 10. To achieve this end, one or more support members 170 are provided. As will be appreciated, the support members 170 are rigid members, such as metal cross beams, that serve to hold the rack members 10 a certain distance apart and in a predetermined orientation. Added rigidity may make the rack more suited to carrying heavy loads or loads needing securing support along an extended length.

An advantageous feature of this aspect of the embodiment of FIGS. 8 and 9 is that the support members 170 may be inserted into slits 210 in the arms that may also serve to receive securing straps 80 (or vice versa). While supporting straps 210 may be used with various if not all of the embodiments of the invention, FIGS. 8 and 9 depict an alternate or additional means for securing cargo 70 for transport. As depicted, the cargo end 50 may include a strap, rope, cord, or like securing line 80 for belting the cargo in place. To aid in belting the cargo in place, the arm 60 of the rack member 10 preferably includes one or more eyelets 90. These eyelets 90 are preferably spaced along the length of the arm 60 to provide an anchoring post for holding the line 80 in a manner that secures the cargo 70, for example, a carpet being transported. While the depicted embodiment shows an eye hook securing arrangement, one of ordinary skill in the art will appreciate that any suitable means for securing the cargo is contemplated by the invention.

According to this aspect of the invention, any of the rack kits of the invention may be provided with support members 170 that may be used only when needed. For example, when increased rigidity is needed or when it is important to lock the two rack members 10 a given distance apart.

The invention contemplates that the rack 1 of FIGS. 8 and 9 be either configured as a strong integral piece or comprised of parts that may be disassembled for storage. A single integral piece may be desired when either known cargo of a troublesome size is to be transported regularly or when the rack is being manufactured to be a one-use disposable unit. The rack may be made to be disassembled as with other aforementioned embodiments of the invention, the only difference being that this embodiment includes support members 170.

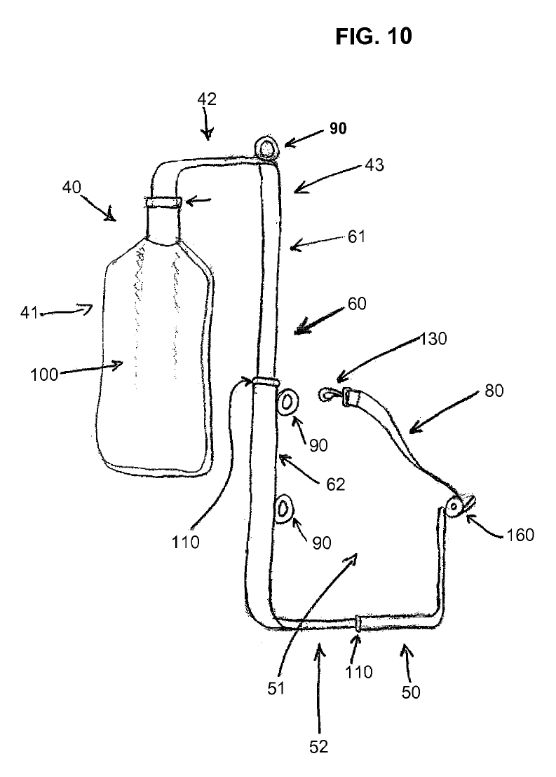

In this regard, another advantageous feature of this embodiment of the invention is that the rack members 10 and/or support members 170 may be configured to allow for adjustability of the distance between the rack members 10 and/or possibly the length of the arms 60. A particularly advantageous embodiment of the invention having adjustable arms is depicted in FIG. 10. While the embodiment illustrated in FIG. 10 has many of the characteristics discussed above, the anchor end 40, the downwardly extending arm 60, and the cargo end 50 all have telescoping joints 110 which allows the rack 10 to accommodate different door sizes and different sized cargo 70. In other words, this embodiment contemplates a somewhat universal applicability to any oversized or elongated cargo.

To be more specific, a telescoping joint 110 allows the anchor end 40 to extend downward to adjust to the contours of the car door 30 and the weight of the cargo 70. The upper end 61 of the downwardly extending arm 60 is separately formed from the lower end 62, with the lower end 62 being larger is periphery such that the upper end 61 slides into it, thereby allowing the arm 60 to retract or extend to adjust to the height of the car and the size of the cargo 70. The cargo end 50 further has a telescoping joint 110 which allows the base 52 of the cargo end 50 to be widened and narrowed and thereby to adjust to the size of the cargo 70. These telescopic joints 110 allow the invention to widen and narrow, lengthen and shorten. Using such telescopic joints 110, the same cargo rack 10 can be modified, for example, to transport both narrow cargo 70, such as plumbing pipe, and wider cargo 70, such as a rolled carpet, by sliding the telescopic joint 110 in the base 52 of the cargo end 50 from a narrow to a wide position. Adjustable parts may also facilitate compacting or bundling the rack into a kit for storage.

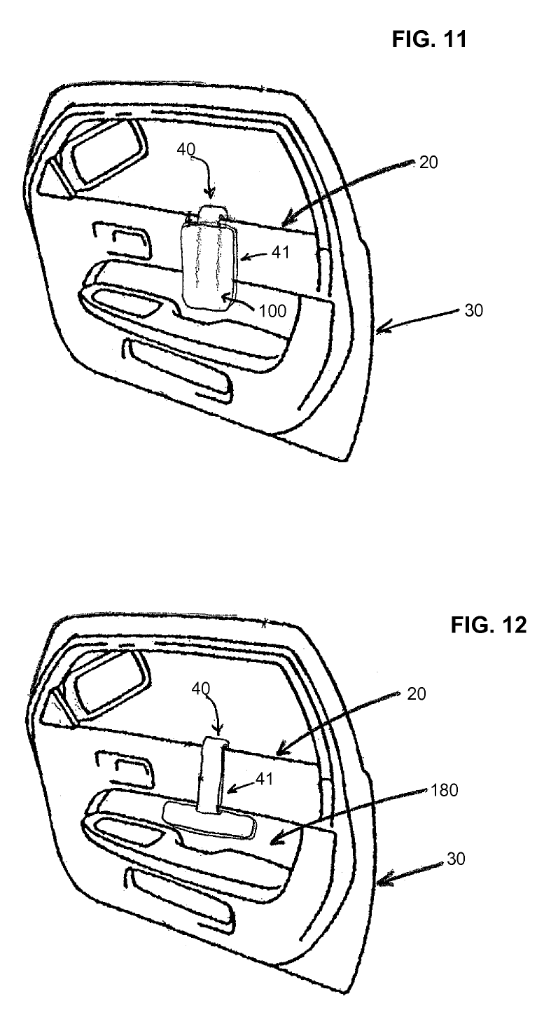

According to yet another aspect of some embodiments of the invention such as that featured in FIG. 10 is the provision of padding 100 on the anchor end. As shown in FIG. 11, the padding may serve to protect the interior of the car door 30, and in some instances a passenger. In addition to padding 100, the inside gripping portion 41 may also be configured to better anchor and hold the rack 1 in place. For example, in the embodiment illustrated in FIG. 12, the inside gripping portion 41 of the anchor end 40 forms an upside-down “T” which fits into a recess 180 on the interior of the car door 30 and results in a snap-fit effect. This embodiment holds the cargo rack 10 onto the car door 30 not only by the weight of the cargo 70 and squeezing pressure between the inside gripping portion 41 and the downwardly extending arm 60, but also due to the inside gripping portion 41 hooking into the interior car door recess 180.

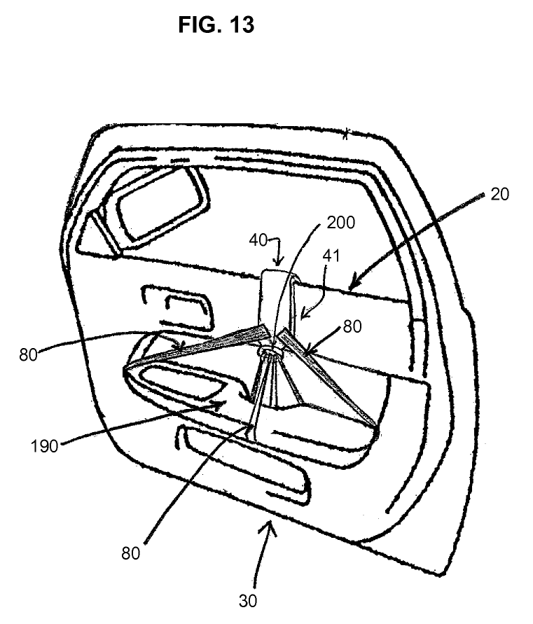

Another example of a means and method of securing the inside gripping portion 41 of the anchor end 40 of the rack 1 to the car door 30 is illustrated in FIG. 13. In this embodiment, the inside gripping portion 41 includes several straps 80 which wrap around the arm rest 190 on the interior of the car door 30. In the depicted embodiment, the straps 80 clip onto a ring 200 on the anchor end 40, thereby anchoring the rack 10 to the car door 30. Other similar means for securing the rack 1 should be evident to one of ordinary skill in the art armed with the present specification.

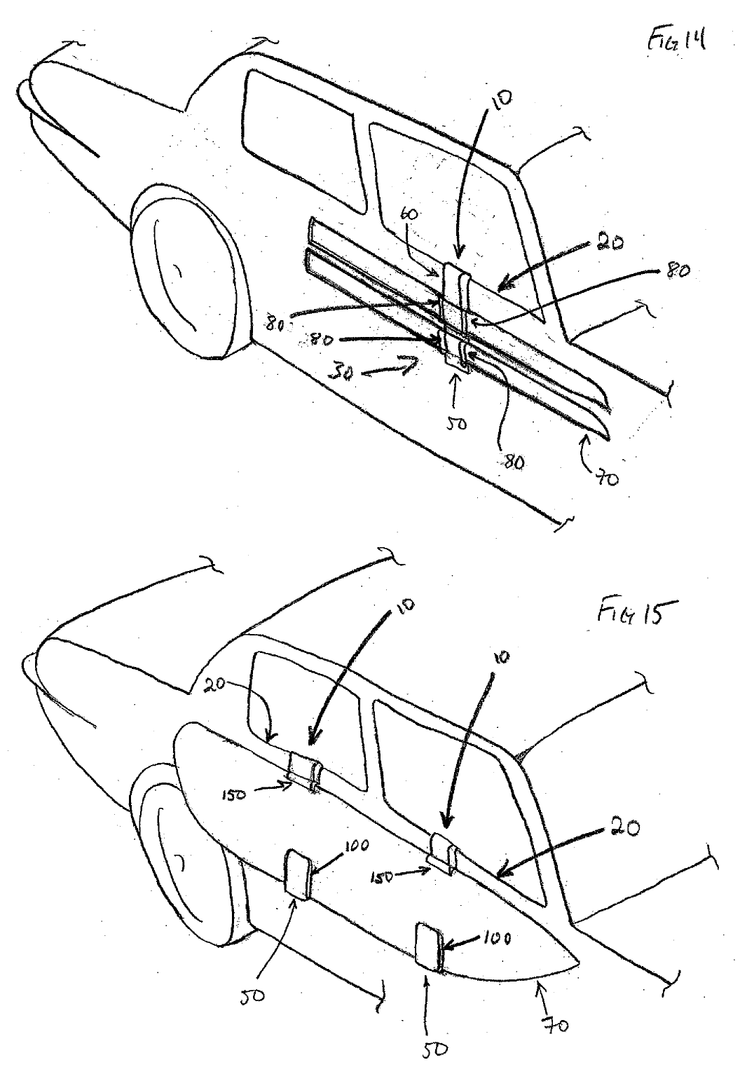

Another feature of the invention is the provision of racks designed for specific types of cargo. For example, FIG. 14 illustrates an embodiment of the invention configured to carry water skis. As depicted, the downwardly extending arm 60 in this embodiment is relatively short, allowing the skis to be positioned farther from the ground and closer to the open window 20 to provide maximum protection from road debris. The cargo end 50 of the rack 1 is includes a specially designed ski receiving and holding area instead of a downwardly extending arm 60. The skis are secured to the rack member 10 by straps 80 containing a strip of nylon with a surface of minute hooks that fasten to a corresponding strip with a surface of uncut pile (for example, that sold under the tradename VELCRO® by Velcro Industries B.V.). Alternatively, the straps 80 might be hand-tied or some other suitable securing means employed instead of straps.

FIG. 15 is an embodiment that illustrates the use of a pair of rack members specially designed for carrying a specific cargo. In this embodiment, a pair of rack members 10 multiple racks 10 define a hook-shaped cargo area 51 specially sized to carry one or possibly more surfboards. The rack members include a snap-fit connector 150 or like means for holding the surfboard secure to the rack. As will be appreciated, similar custom cargo carrying racks can be designed by those of ordinary skill in art to achieve the purpose of the invention in providing a removable side-mounted rack for carry predetermined cargo types.

While the various embodiments of the invention heretofore described may be made of any suitable materials for the intended durability, portability and expense of the rack, it may be desirable to construct the rack out of material or include padding to protect the car door and the cargo from scratching, tearing, or the like. For example, the cargo ends 50 of the racks 10 illustrated in FIG. 15 have padding 100 to protect the surfboard. The racks 10 in FIGS. 7 and 9 also have padding 100 to protect the exterior surface of the car door 30, and as discussed above, the inside gripping portion 41 of the anchor end 40 of the rack 10 can also have padding 100 to protect the interior of the car door 30 or the passenger.

Given the foregoing, it should be apparent that the specifically described embodiments are illustrative and not intended to be limiting. Furthermore, variations and modifications to the invention should now be apparent to a person having ordinary skill in the art. These variations and modifications are intended to fall within the scope and spirit of the invention as defined by the following claims.

I claim:

1. A removable cargo rack for use in the open window of a car door comprising:
an anchor end adapted to removably engage the open window of the car door,
a cargo end adapted to retain and support the cargo, and
a downwardly extending arm disposed between said anchor end and said cargo end.

2. The removable cargo rack of claim 1 wherein said anchor end is adapted to attach to the arm rest on the interior of the car door.

3. The removable cargo rack of claim 1 wherein said downwardly extending arm is integrally formed with at least one of said anchor end and said cargo end.

4. The removable cargo rack of claim 1 wherein said downwardly extending arm is adapted to retain and support the cargo.

5. The removable cargo rack of claim 1 including at least one means for securing the cargo.

6. The removable cargo rack of claim 5 wherein said means for securing the cargo includes at least one of the group consisting of rings, hooks, loops, slots, buckles, straps, tighteners, fasteners, clips, and snap-fit connectors.

7. The removable cargo rack of claim 1 including at least one telescoping joint.

8. The removable cargo rack of claim 1 including padding adapted to protect at least one of the group consisting of the automobile door and the cargo.

9. A cargo rack assembly comprising a plurality of removable cargo racks as set forth in claim 1.

10. The cargo rack assembly of claim 9 further comprising a connection member adapted to connect said plurality of removable cargo racks.

11. The cargo rack assembly of claim 10 wherein said connection member retains and supports the cargo.

12. The cargo rack assembly of claim 10 wherein said connection member includes at least one telescoping joint.
